(19) United States
(12) Patent Application Publication
(10) Pub. No.: US 2003/0233333 A1
(43) Pub. Date: Dec. 18, 2003

(54) Remittance intermediating service system and method of providing the same

(76) Inventors: Dae Hyung Lee, Seoul (KR); Myung Ok Yang, Incheon-City (KR)

Correspondence Address: ROBERT E. BUSHNELL, 1522 K STREET N. W., SUITE 300, WASHINGTON, DC, 20005, US

(21) Appl. No.: 10/170,410

(22) Filed: Jun. 14, 2002

(51) Int. Cl. G06F 17/60

(52) U.S. Cl. 705/75

(57) ABSTRACT

A remittance intermediating service system includes a service provider server which receives a remittance request including a remitter's account information, a recipient's account information and a remittance amount. A client browser, equipped with screen scraping modules, receives a first remittance request and a remitter's certification information from the service provider server, accesses a computer system of a first bank containing the remitter's account, remits the remittance amount from the remitter's account to a first mother account of the service provider contained in the same bank, and sends a remittance result to the service provider server. A plurality of screen scraping terminals receive a second remittance request from the service provider server, remit the remittance amount from a second mother account of the service provider contained in a second bank to a recipient's account contained in the second bank, and send a remittance result to the service provider server.

### BACKGROUND OF THE INVENTION

1. Field of the Invention

The present invention relates to electronic commerce, and more particularly, the present invention relates to a remittance intermediating service system and to a method of providing a remittance intermediating service.

The invention is related to the subject matter contained in commonly assigned Korean Patent Application Serial No. 2000-39754, filed Jul. 12, 2000, entitled “Transaction System Using Cyber Personal Account” and Korean Patent Application No. 2000-43183, filed Jul. 26, 2000, entitled “Mother Account Remittance System And Method Of Remitting Using The Same”, the contents of which are incorporated herein by reference.

2. Description of the Related Art

Internet banking services are now available which allow customers to conduct banking transactions online by providing access to bank owned and/or operated web sites. Such services include deposits and withdrawals, balance inquiries, loan applications, credit card activities, automatic transfers of funds, and so on. Typically, security systems having certification processes are adopted to allow customer access to accounts in a secure and safe manner.

In the meantime, “account aggregation” services have developed which provide customers with the ability to access information about all of their financial transactions sourced from different web sites, at a single web site. This service collects banking information from different financial institutions (bank, saving institution, securities firm, etc.) and provides the user with the collected information. Using this technique, the user can conduct banking processes, such as balance inquiries and account transfers, associated with different financial institutions without individually accessing the web sites of these financial institutions.

Account aggregation is enabled by a technology known as “screen scraping.” Generally, the account aggregation web site accesses the customer's financial institution web sites (using passwords previously provided by the customer), and is equipped with software that collects and interprets data indicative of the display screens associated with each of the customer's financial institution(s). Information from multiple accounts is maintained for each customer at the account aggregation web site. From the customer's perspective, only the account aggregation web site is accessed. Account aggregation and screen scraping have resulted in personal financial management systems (PFMS) in which the financial data from multiple accounts are collected and are analyzed, and the analyzed data is presented to the customer in report formats and so on.

FIG. 1 is a schematic view of a conventional remittance process between two different banks.

In this example, payment transactions of all financial institutions are processed via the Korean Financial Telecommunications & Clearings Institute 300, which is formed as a joint-investment of the banks. Specifically, a remitter sends a request to the Institute 300 for a remittance from the remitter's account 100a of the remitter's bank 100 to the recipient's account 200b of the recipient's bank 200. Here, the bank 100 and the bank 200 are different banks, whereas the remitter and recipient may or may not be different persons. Then, the Institute 300 sends the transaction text to the recipient's bank 200, whereby a deposit is completed. As a result, the remittance amount is withdrawn from the remitter's account 100a and the withdrawn amount is added to the recipient's account 200b. Cash is not transferred directly from the remitter's bank 100 to the recipient's bank 200. Instead, the next banking day the Bank of Korea withdraws the remittance amount from checking account of the remitter's bank 100 and deposits the same to the checking account of the recipient's bank 200. In addition, since the remittance between different banks is processed (controlled) via the Institute 300, the customer must pay a remittance commission, which is set unilateral by the financial institutions.

Presently, the payment of a commission cannot be avoided even when using Internet banking services, screen scraping technologies, account aggregation and PFMS. While customers can process banking transactions through Internet banking services and without directly going to the bank, the customer must still pay the remittance commission. Further, although the PFMS can provide the customer with the financial services such as the financial information aggregation and the analysis of aggregated information, it cannot settle the remittance commission.

### SUMMARY OF THE INVENTION

It is an object of the present invention to provide a remittance intermediating service system, and a method of providing a remittance intermediating service, which allow for the avoidance of a customer-paid remittance commission when processing a remittance between different banks.

It is another object of the present invention to provide a remittance intermediating service system, and a method of providing the remittance intermediating service, which securely handles private and confidential customer information using screen scraping technology.

According to an aspect of the present invention, a remittance intermediating service system is provided which includes a service provider server which receives a remittance request including a remitter's account information, a recipient's account information and a remittance amount; a client browser, equipped with screen scraping modules, which receives a first remittance request and loads a certification of a first bank containing the remitter's account from the service provider server, which accesses a computer system of the first bank containing the remitter's account, which remits the remittance amount from the remitter's account to a first mother account of the service provider contained in the first bank, and which sends a remittance result to the service provider server; and a plurality of screen scraping terminals which receive a second remittance request from the service provider server, which remit the remittance amount from a second mother account of the service provider contained in a second bank to a recipient's account contained in the second bank, and which sends a remittance result to the service provider server. The system may further include a database which stores data indicative of the remittance result from the remitter's account to the first mother account and which stores data indicative of the remittance result from the second mother account to the recipient's account.

Generally, the service provider server sends to the client browser a remittance request from the remitter's account to a mother account of the service provider in the same bank. Further, the service provider server sends to the screen scraping terminals a remittance request from another mother account of the service provider at the recipient's bank to the recipient's account. The service provider server receives the remittance results processed by the client browser and the screen scraping terminals and saves the remittance results in the database.

The mother accounts are actual accounts of the service provider which are capable of deposits and withdraws and which are used to transact with the remitter's account and the recipient's account.

In other words, the present invention is generally characterized by a first step of remitting from the remitter's account to a first mother account of the service provider in a same bank, and a second step of remitting from a second mother account of the service provider to the recipient's account in another same bank.

The remittance from the remitter's account to the first mother account and the remittance from the second mother account to the recipient's account are processed in the same manner as any conventional intra-bank remittance.

According to the preferred embodiments, the service provider server manages and controls the remittance intermediating service system. More specifically, the service provider server receives a remittance request including remitter's account information, recipient's account information and remittance amount. The service provider server sends to the client browser the remittance request from the remitter's account to the mother account in the same bank. Further, the service provider server sends to the screen scraping terminals the remittance request from the mother account of the recipient's bank to the recipient's account. The service provider server also receives remittance results processed by the client browser and the screen scraping terminals and saves the remittance results in the database.

The remitter's account information and the recipient's account information include an account number, a ID number and depositor. The service provider server includes a first function to confirm whether the remitter's account information and the recipient's account information are correct; a second function to confirm whether the remitter's account and the recipient's account are normal accounts; and a third function to confirm whether the remitter's balance and the balance of the mother account in the recipient's bank are more than the remittance amount.

More specifically, the service provider server confirms whether the account number, the ID number and depositor of the remitter's account and the recipient's account are identical; and whether the remitter's account and the recipient's account are currently capable of deposits and withdraws. Further, the service provider server confirms whether the balance of the account for remittance, that is, the remitter's balance and the balance of the mother account of the recipient's bank are more than the remittance amount. If the balance of the remitter's account and the mother account are insufficient, the service provider server displays and/or generates an alert message.

After completing the above-described confirmation, the service provider server sends the remittance request from the remitter's account to the first mother account to the screen scraping modules of the client browser and the remittance request from the second mother account to the recipient's account to the screen scraping terminals. The remittances are processed through the remitter's own bank system and the recipient's own bank system, respectively.

After completing the above remittances, the service provider server receives the remittance results processed by the screen scraping modules and the screen scraping terminals and saves the remittance results in the database. The remittance results include confirmation of the remittance completion and balance information of the mother accounts.

The balance information of the mother accounts is required to balance theses accounts. If the balance of a mother account in a certain bank is too high, the balance of the mother accounts in other banks could be possibly insufficient. Accordingly, when the balance one or more mother accounts is a predetermined amount or less, the service provider server generates an alert message so that the service provider can provide sufficient funds to any affected mother account.

The client browser receives the remittance request and the remitter's certification information from the service provider server, accesses the computer system of the bank with which the remitter's account is opened, remits an amount from the remitter's account to the first mother account, and sends the remittance result to the service provider server.

The client browser is equipped with screen scraping modules capable of scraping the web page of a bank in order to remit from the remitter's account to the mother account of the service provider. It is preferable that screen scraping modules are ActiveX.

In the embodiment, the remittance from the remitter's account to the mother account is processed on the client browser because the remitter's certification process is required. The account number, ID number and certification information of the remitter may be needed in order to withdraw the amount from the remitter's account. That is, in cases where it is prohibited legally to receive and save certification information from the service provider server, the remittance is processed on the client browser having screen scraping modules.

The remittance to the recipient's account is processed through the screen scraping terminals. Specifically, the screen scraping terminals receive the remittance request from the service provider server, remit an amount from the second mother account to the recipient's account, and send the remittance result to the service provider server.

The service provider server collects the remittance results received by the client browser and the screen scraping terminals, and saves the remittance results in the database. Again, the remittance results may include the mother account balances.

According to another aspect of the present invention, a method of providing a remittance intermediating service includes receiving a remitter's request including a remitter's account information, a recipient's account information, and a remittance amount; sending a first remittance request including remitter's account information, a first mother account information and remittance amount to a client browser equipped with screen scraping modules; accessing a computer system of the remitter's bank using the screen scraping modules; remitting the remittance amount from the remitter's account to the first mother account, wherein the first mother account is an account of a service provider contained in the remitter's bank; receiving a first remittance result indicative of the remittance from the remitter's account to the first mother account, and saving first remittance result in a database; sending a second remittance request including recipient's account information, a second mother account information and the remittance amount to a plurality of screen scraping terminals; accessing a computer system of the recipient's bank using the screen scraping terminals; remitting the remittance amount from the second mother account to the recipient's account, wherein the second mother account is another account of the service provider contained in the recipient's bank; receiving a second remittance result indicative of the remittance from the second mother account to the recipient's account, and saving second remittance result in the database.

Prior to remitting the remittance amount from the remitter's account to the first mother account, the method may further include confirming whether the remitter's account information and the recipient's account information are correct, confirming whether the remitter's account and the recipient's account are normal accounts, and confirming whether the remitter's account balance and the balance of the second mother account balance are more than the remittance amount.

According to still another aspect of the present invention, a method is provided for emulating an inter-bank remittance between first and second financial institutions, the inter-bank remittance being defined by a remitter having an remitter account at the first financial institution, a recipient having a recipient account at the second financial institution, and a remittance amount, the method including maintaining first and second mother accounts at the first and second financial institutions, respectively; receiving a request for the inter-bank transmittance from the remitter; sending a transmittance request to a computer system of the first financial institution to transfer the remittance amount from the remitter account to the first mother account; and sending a second transmittance request to a computer system of the second financial institution to transfer the remittance amount from the second mother account to recipient's account.

### BRIEF DESCRIPTION OF THE DRAWINGS

These and other objects, features and advantages of the present invention will be readily understood from the detailed description that follows, with reference to the accompanying drawings, in which like reference numerals designate like structural elements, and in which:

FIG. 1 is a schematic view of a conventional remittance process between different banks;

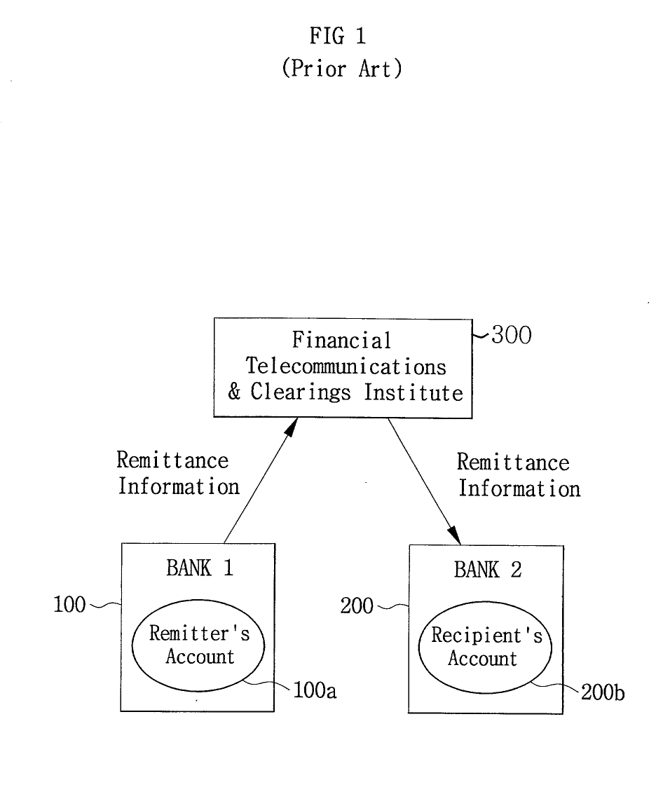

FIG. 2 is a schematic view of a remittance process between different banks in accordance with an embodiment of the present invention;

FIG. 3 is a system diagram of a remittance intermediating service system in accordance with an embodiment of the present invention; and

FIG. 4 is a block flow diagram of a remittance intermediating service procedure in accordance with an embodiment of the present invention.

### DETAILED DESCRIPTION OF PREFERRED EMBODIMENTS

Hereinafter, embodiments of the invention will be described in detail with reference to the drawings. It is noted that the illustrations may not necessarily be drawn to scale and that there may be other embodiments to this invention that are not specifically illustrated.

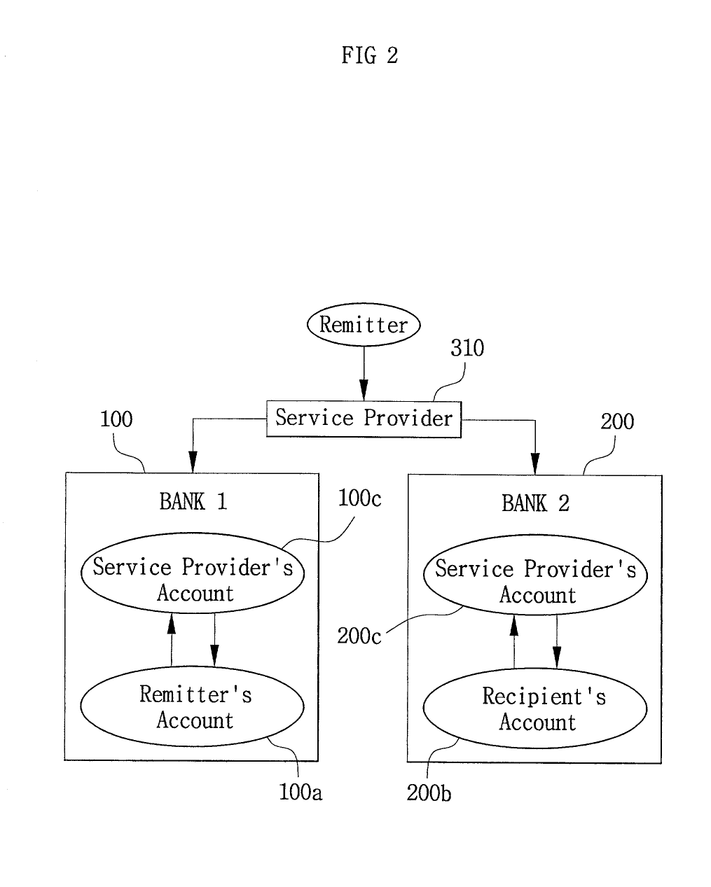

FIG. 2 is a schematic view of a remittance process between two different banks in accordance with an embodiment of the present invention. A service provider is equipped with a server(s) 310 which is external of the computer systems (e.g., web servers, etc.) of first and second banks 100 and 200. In addition, the service provider maintains “mother” accounts 100c and 200c in the banks 100 and 200, respectively. In response to the receipt by the service provider server 310 of a remittance request from a remitter, the service provider server 310 sends the remittance request to the computer system of the remitter's bank 100 having an active remitter's account 100a. In addition, the remittance request is sent to the computer system of a recipient's bank 200 having an active recipient's account 200b.

In accordance with the remittance request, the remittance is processed from the remitter's account 100a to the service provider's mother account 100c within the same bank 100. Further, the remittance is processed from service provider's mother account 200c to the recipient account 200b within the same bank 200.

Data indicative of the remittance from the remitter's account 100a to the mother account 100c, and the remittance from the mother account 200c of the service provider server 310 to the recipient's account 200b, are sent to the service provider server 310 and saved to a database. In this manner, the remittance is completed between two different banks from the remitter's account 100a to the recipient's account 200b. However, from the banks' perspective, only internal transactions were conducted, and accordingly no commission fee is generated.

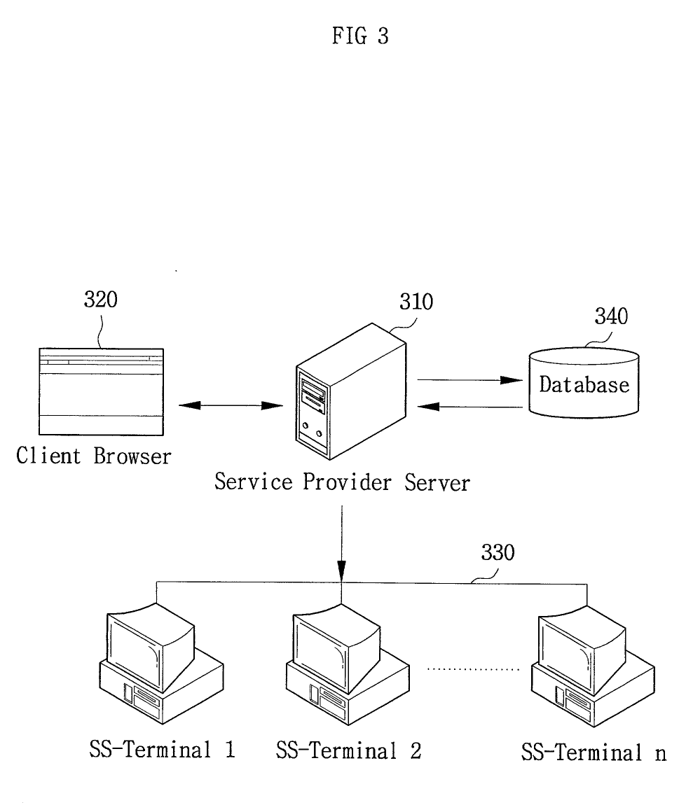

FIG. 3 is a system diagram of the remittance intermediating service system in accordance with an embodiment of the present invention. The system includes a service provider server 310, a client browser 320, screen scraping terminals 330 and a database 340. The client browser 320 is equipped with screen scraping modules and, for example, ActiveX may be used as the screen scraping modules.

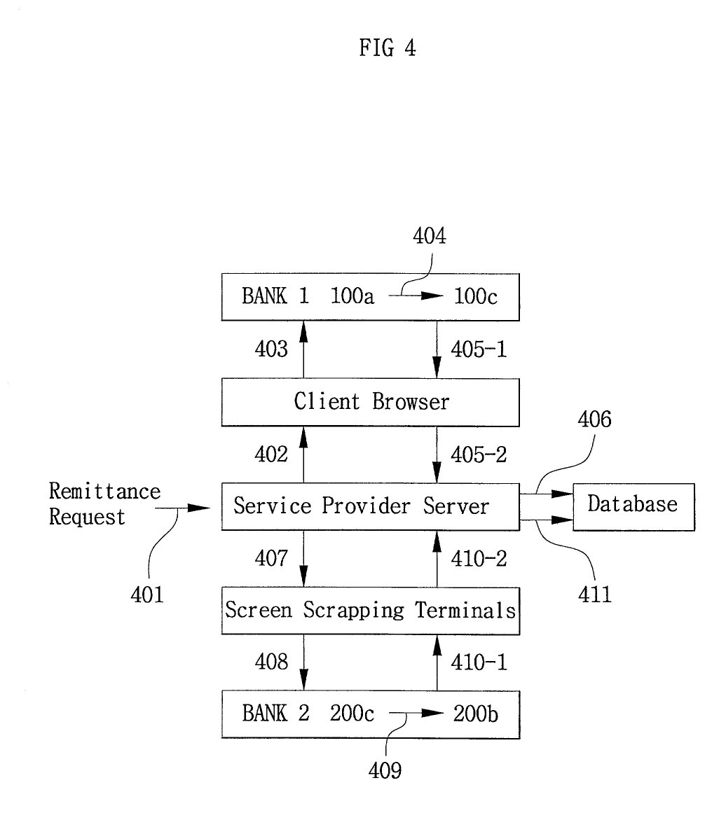

FIG. 4 is a block flow diagram of the remittance intermediating service procedure in accordance with an embodiment of the present invention.

As shown in FIG. 4, in step 401, the service provider server 310 receives a remittance request including a remitter's account information, a recipient's account information and a remittance amount. In step 402, the service provider server 310 sends the remittance request to the client browser 320 having the screen scraping modules. In step 403, the client browser 320 accesses the system of the remitter's bank, with which the remitter's account is opened, through the screen scraping modules. Then, in step 404, the remittance is processed from the remitter's account 100a of the remitter's bank 100 to the service provider's mother account 100c within the same bank 100. In step 405, the process result of step 404 is sent to the service provider server 310 and in step 406, the process result is saved to the database 340.

In step 407, the service provider server 310 sends the remittance request to the screen scraping terminals 330. In step 408, the screen scraping terminals 330 access the system of the recipient's bank 200, with which the recipient's account is opened. Then, in step 409, the remittance is processed from the service provider's mother account 200c in the bank 200 to the recipient's account 200b of the same bank 200. In step 410, the process result of step 409 is sent to the service provider server 310, and in step 411, the process result is saved to the database 340.

As described above, the customer does not need to pay an inter-bank remittance commission since all actual remittances are conducted on an intra-bank basis. Further, the use of screen scraping technologies reduces the risk of confidential customer information being intercepted or misappropriated.

In the drawings and specification, there have been disclosed typical preferred embodiments of this invention and, although specific terms are employed, they are used in a generic and descriptive sense only and not for purposes of limitation, the scope of this invention being set forth in the following claims.

What is claimed is:

1. A remittance intermediating service system, comprising:
a service provider server which receives a remittance request including a remitter's account information, a recipient's account information and a remittance amount;
a client browser, equipped with screen scraping modules, which receives a first remittance request and loads a certification of a first bank containing the remitter's account from the service provider server, which accesses a computer system of the first bank containing the remitter's account, which remits the remittance amount from the remitter's account to a first mother account of the service provider contained in the first bank, and which sends a remittance result to the service provider server; and
a plurality of screen scraping terminals which receive a second remittance request from the service provider server, which remit the remittance amount from a second mother account of the service provider contained in a second bank to a recipient's account contained in the second bank, and which send a remittance result to the service provider server.

2. The system of claim 1, further comprising a database which stores data indicative of the remittance result from the remitter's account to the first mother account and which stores data indicative of the remittance result from the second mother account to the recipient's account.

3. The system of claim 1, wherein the first remittance request includes the remitter's account information, the first mother account information and the remittance amount, and wherein the second remittance request includes the recipient's account information, the second mother account information and the remittance amount.

4. The system of claim 1, wherein the remittance from the remitter's account to the first mother account are processed through the first bank, and wherein the remittance from the second mother account to the recipient's account are processed through the second bank.

5. The system of claim 1, wherein the service provider server includes a first function to confirm whether the remitter's account information and the recipient's account information are correct; a second function to confirm whether the remitter's account and the recipient's account are normal accounts; and a third function to confirm whether the remitter's balance and the balance of the second mother account are more than the remittance amount.

6. The system of claim 5, wherein the first function includes confirming whether an account number, an ID number and a depositor are identical.

7. The system of claim 5, wherein the second function includes confirming whether the remitter's account and the recipient's account are currently set up for deposits and withdraws.

8. The system of claim 1, wherein the remittance results include balance inquiries of the first and second mother accounts.

9. The system of claim 1, wherein the client browser is ActiveX.

10. The system of claim 8, wherein the service provider server generates an alarm message if a balance of at least one of the first and second mother accounts is less than a given amount.

11. A method of providing a remittance intermediating service, comprising:
receiving a remitter's request including a remitter's account information, a recipient's account information, and a remittance amount;
sending a first remittance request including remitter's account information, a first mother account information and remittance amount to a client browser equipped with screen scraping modules; accessing a computer system of the remitter's bank using the screen scraping modules; remitting the remittance amount from the remitter's account to the first mother account, wherein the first mother account is an account of a service provider contained in the remitter's bank; receiving a first remittance result indicative of the remittance from the remitter's account to the first mother account, and saving first remittance result in a database;
sending a second remittance request including recipient's account information, a second mother account information and the remittance amount to a plurality of screen scraping terminals; accessing a computer system of the recipient's bank using the screen scraping terminals; remitting the remittance amount from the second mother account to the recipient's account, wherein the second mother account is another account of the service provider contained in the recipient's bank; receiving a second remittance result indicative of the remittance from the second mother account to the recipient's account, and saving second remittance result in the database.

12. The method of claim 11, wherein, prior to remitting the remittance amount from the remitter's account to the first mother account, said method further comprises:
confirming whether the remitter's account information and the recipient's account information are correct,
confirming whether the remitter's account and the recipient's account are normal accounts, and
confirming whether the remitter's account balance and the balance of the second mother account balance are more than the remittance amount.

13. The method of claim 12, wherein the confirming of whether the remitter's account information and the recipient's account information are correct includes confirming whether an account number, an ID number and a depositor are identical.

14. The method of claim 11, wherein the remittance results include the inquiry result of the balance of the mother account.

15. A method of emulating an inter-bank remittance between first and second financial institutions, the inter-bank remittance being defined by a remitter having an remitter account at the first financial institution, a recipient having a recipient account at the second financial institution, and a remittance amount, said method comprising:
maintaining first and second mother accounts at the first and second financial institutions, respectively;
receiving a request for the inter-bank transmittance from the remitter;
sending a transmittance request to a computer system of the first financial institution to transfer the remittance amount from the remitter account to the first mother account; and
sending a second transmittance request to a computer system of the second financial institution to transfer the remittance amount from the second mother account to recipient's account.

16. The method of claim 15, further comprising receiving confirmation of the transfer of the remittance amount from the remitter account to the first mother account prior to sending the second transmittance request.

17. The method of claim 15, wherein the first and second mother accounts are maintained by a service provider which provides accounts aggregation services to at least the remitter.
